(19) United States
(12) Patent Application Publication
(10) Pub. No.: US 2014/0129670 A1
(43) Pub. Date: May 8, 2014

(54) METHOD AND APPARATUS FOR MODIFYING UNIQUE IDENTIFIERS ASSOCIATED WITH A WEB BROWSER

(71) Applicant: IAN Justin OLIVER, Söderkulla (FI)

(72) Inventor: IAN Justin OLIVER, Söderkulla (FI)

(73) Assignee: Nokia Corporation, Espoo (FI)

(21) Appl. No.: 13/671,296

(22) Filed: Nov. 7, 2012

(51) Int. Cl. G06F 15/16

(52) U.S. Cl. 709/217

(57) ABSTRACT

An approach is provided for modifying unique identifiers and/or analyzing regenerated identifiers. The modification manager determines one or more fields associated with an identification of at least one web browser. The modification manager causes, at least in part, one or more modifications of respective ones of the one or more fields based, at least in part, on one or more amounts of information, one or more types of information, or a combination thereof associated with the identification. The modification manager causes, at least in part, at least one transmission of data associated with the at least one web browser based, at least in part, on the one or more modified fields.

### BACKGROUND

Service providers and device manufacturers (e.g., wireless, cellular, etc.) are continually challenged to deliver value and convenience to consumers by, for example, providing compelling network services. One area of interest among service providers and device manufacturers has been the protection of private or sensitive information pertaining to a user or user devices that communicate over a network (e.g., the Internet). By way of example, many applications and services operable by a user device (e.g., a mobile phone or a tablet) employ the use of identifiers (e.g., Hypertext Transfer Protocol (HTTP) headers) for communicating with various severs and/or backend databases that the applications or the services require for fulfilling application processing tasks. These identifiers also enable third parties (e.g., analytic services, advertising services, social networking services, etc.) to track a web browser's requests for content and/or transmissions of data to the various servers, for example. Consequently, a “Do Not Track” (DNT) policy was collaboratively developed to enable users to modify a DNT header of their web browser to opt-out or restrict third parties from tracking such requests and/or transmissions. However, DNT is a cooperative solution based on an honor system and, therefore, not universally accepted. Moreover, even if DNT was universally accepted, third parties can still readily track a web browser's requests and/or transmissions based on one or more unique identifiers or “fingerprints” associated with the web browser (e.g., features such as entity tags (ETags), plugins, system fonts, User-Agent strings, etc.). At the same time, another area of interest has been the development of analytical tools that enable statistical inferences to be made from a modification of the identifiers (e.g., implementing regenerable identifier structures) even when a web browser imposes restrictions upon the amounts and types of information being presented via the identifiers. However, there is no mechanism for effectively determining the number of times (or rate) an identifier has been regenerated.

### SOME EXAMPLE EMBODIMENTS

Therefore, there is a need for an approach for modifying unique identifiers and/or analyzing regenerated identifiers.

According to one embodiment, a method comprises determining one or more fields associated with an identification of at least one web browser. The method also comprises causing, at least in part, one or more modifications of respective ones of the one or more fields based, at least in part, on one or more amounts of information, one or more types of information, or a combination thereof associated with the identification. The method further comprises causing, at least in part, at least one transmission of data associated with the at least one web browser based, at least in part, on the one or more modified fields.

According to another embodiment, an apparatus comprises at least one processor, and at least one memory including computer program code for one or more computer programs, the at least one memory and the computer program code configured to, with the at least one processor, cause, at least in part, the apparatus to determine one or more fields associated with an identification of at least one web browser. The apparatus also causes, at least in part, one or more modifications of respective ones of the one or more fields based, at least in part, on one or more amounts of information, one or more types of information, or a combination thereof associated with the identification. The apparatus further causes, at least in part, at least one transmission of data associated with the at least one web browser based, at least in part, on the one or more modified fields.

According to another embodiment, a computer-readable storage medium carries one or more sequences of one or more instructions which, when executed by one or more processors, cause, at least in part, an apparatus to determine one or more fields associated with an identification of at least one web browser. The apparatus also causes, at least in part, one or more modifications of respective ones of the one or more fields based, at least in part, on one or more amounts of information, one or more types of information, or a combination thereof associated with the identification. The apparatus further causes, at least in part, at least one transmission of data associated with the at least one web browser based, at least in part, on the one or more modified fields.

According to another embodiment, an apparatus comprises means for determining one or more fields associated with an identification of at least one web browser. The apparatus also comprises means for causing, at least in part, one or more modifications of respective ones of the one or more fields based, at least in part, on one or more amounts of information, one or more types of information, or a combination thereof associated with the identification. The apparatus further comprises means for causing, at least in part, at least one transmission of data associated with the at least one web browser based, at least in part, on the one or more modified fields.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of modifying unique identifiers and/or analyzing regenerated identifiers, according to one embodiment;

FIG. 2 is a diagram of the components of a modification platform/modification manager, according to one embodiment;

FIG. 3-5 are flowcharts of processes for modifying unique identifiers and/or analyzing regenerated identifiers, according to one embodiment;

FIG. 6 is a diagram of a workflow for modifying unique identifiers associated with a web browser, according to one embodiment;

FIG. 7 is also a diagram of components of a modification platform/modification manager, according to one embodiment;

FIG. 8 are diagrams of user interfaces utilized in the processes of FIG. 3-5, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for modifying unique identifiers and/or analyzing regenerated identifiers are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

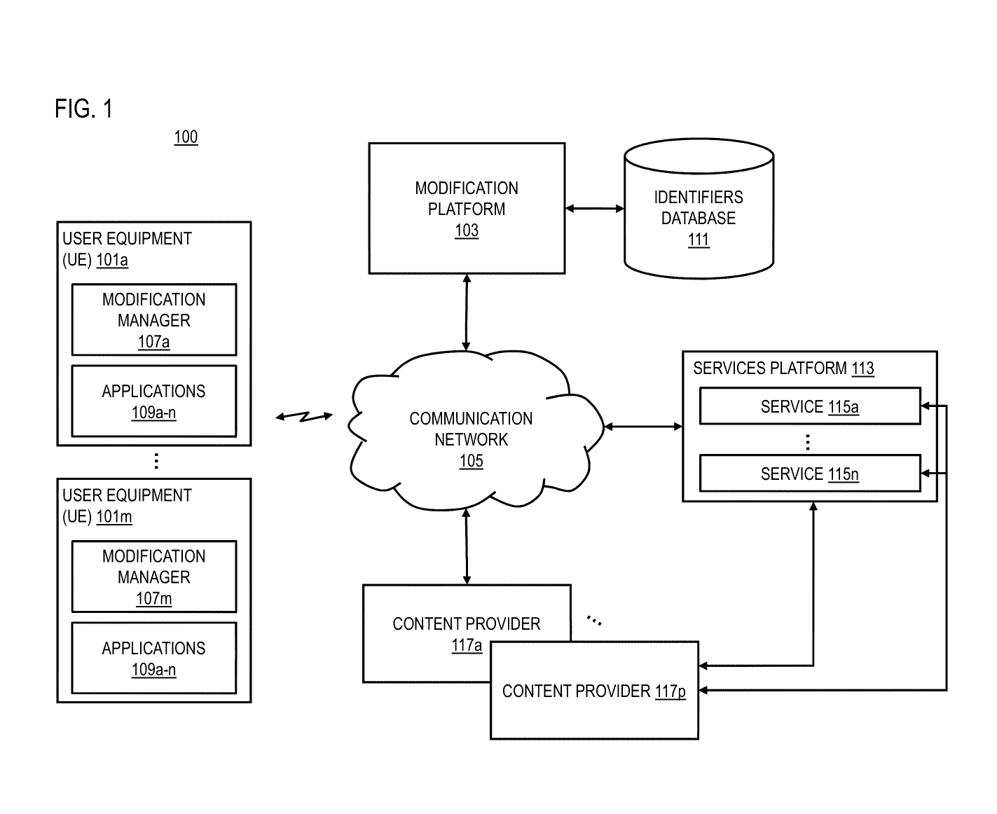

FIG. 1 is a diagram of a system capable of modifying unique identifiers and/or analyzing regenerated identifiers, according to one embodiment. As previously discussed, one area of interest among service providers and device manufacturers has been the protection of private or sensitive information pertaining to a user or user devices that communication over a network (e.g., the Internet). By way of example, many applications and services operable by a user device (e.g., a mobile phone or a tablet) employ the use of identifiers (e.g., HTTP headers) for communicating with various severs and/or backend databases that the applications or services require for fulfilling application processing tasks. These identifiers also enable third parties to track a web browser's requests for content and/or transmissions of data to the various servers, for example. Consequently, a DNT flag was collaboratively developed to enable users to modify the DNT header of their web browser to opt-out or prevent third parties from tracking a user's requests and/or transmissions. By way of example, the third parties may include “casual” commercial parties (e.g., individual web sites writing their own code), dedicated commercial parties (e.g., a company selling a tracking system), and/or state-level actors. However, DNT is a cooperative solution and, therefore, compliance is based on an honor system. Moreover, even if DNT was universally implemented, third parties can still readily track a web browser's requests and/or transmissions based on one or more unique identifiers associated with the browser. For example, two web browsers may be differentiated by a third-party (e.g., Panopticlick) based, at least in part, on a feature detection of a version type, a type of personalization, installed plugins, installed plugin versions, plugin personalization (e.g., NoScript whitelist), etc. Further, two operating systems may similarly be differentiated based, at least in part, on a version type, a sub-version type, a patch level, a type of personalization (e.g., particular fonts). At the same time, another area of interest has been the development of analytical tools that enable various statistical inferences to be made from a modification of the identifiers (e.g., implementing regenerable identifier structures) even when a web browser imposes restrictions upon the amounts and types of information being presented via the identifiers. However, there is no mechanism for effectively determining the number of times (or frequency) an identifier has been regenerated.

To address this problem, a system 100 of FIG. 1 introduces the capability to modifying unique identifiers and/or analyzing regenerated identifiers. As shown in FIG. 1, the system 100 comprises one or more user equipment (UE) 101a-101m (e.g., mobile phones, tablets, personal computers, etc.) having connectivity to modification platform 103 via a communication network 105. The UEs 101 include or have access to one or more modification managers 107a-107m. While it is contemplated that the modification platform 103 and the modification manager 107 are interchangeable, the various embodiments of the present invention disclosed herein mainly reference the modification manager 107 for the sake of explanation. The UEs 101 also include or have access to one or more applications 109a-109m (also collectively referred to as applications 109). By way of example, the applications 109 may include a web browser, a social networking application, etc. In one embodiment, the modification manager 107 may exist in whole or in part within an application 109 (e.g., a web browser), or independently.

In one embodiment, the modification platform 103/the modification manager 107 may include or be associated with at least one identifiers database 111. In one example embodiment, the modification platform 103 may exist in whole or in part within a UE 101, or independently, and the identifiers database 111 may exist in whole or in part within the modification platform 103, the modification manager 107, or independently. In one embodiment, the identifiers database 111 may include one or more standard sets of headers, one or more hashing parameters, one or more encryption parameters, one or more counting parameters, or a combination thereof.

The UEs 101 are also connected to a services platform 113 via the communication network 105. The services platform 113 includes one or more services 115a-115n (also collectively referred to as services 115). The services 115 may include a wide variety of content provisioning services for the applications 109. By way of example, the services 115 may include web browser updating services, analytical services, encryption services, social networking services, etc. The UEs 101, the services platform 113, and the services 115 also have connectivity to one or more content providers 117a-117p (also collectively referred to as content providers 117) via the communication network 105. The content providers 117 also may provision a wide variety of content (e.g., statistical probability graphs, temporal maps, etc.) to the components of the system 100.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UEs 101 are any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UEs 101 can support any type of interface to the user (such as “wearable” circuitry, etc.).

In one embodiment, the system 100 determines one or more fields associated with an identification of at least one web browser. By way of example, the one or more fields include, at least in part, one or more HTTP headers associated with at least one transmission of data (e.g., when a web browser requests content from a server or sends data to a server). In one example use case, a typical set of headers and information may include, at least in part, the following:

GET / HTTP/1.1[CRLF]
Host: news.bbc.co.uk[CRLF]
Connection: close[CRLF]
DNT: 1[CRLF]
User-Agent: Web-sniffer/1.0.41 (+http://web-sniffer.net/)[CRLF]
Accept-Encoding: gzip[CRLF]
Accept-Charset: ISO-8859-1,UTF-8;q=0.7,*;q=0.7[CRLF]
Cache-Control: no-cache[CRLF]
Accept-Language: de,en;q=0.7,en-us;q=0.3[CRLF]
Referer: http://web-sniffer.net/[CRLF]
[CRLF]

In one embodiment, the system 100 determines the one or more respective fields based, at least in part, on one or more requirements associated with at least one transmission of data by the at least one web browser (e.g., an HTTP call), at least one activation of a “Do Not Track” header or flag associated with the at least one browser, or a combination thereof. By way of example, continuing with the previously discussed example, the one or more fields required for the at least one transmission include, at least in part, the following HTTP header fields:

Accept-Encoding: gzip[CRLF]
Accept-Charset: ISO-8859-1,UTF-8;q=0.7,*;q=0.7[CRLF]
Cache-Control: no-cache[CRLF]
Accept-Language: de,en;q=0.7,en-us;q=0.3[CRLF]
Referer: http://web-sniffer.net/[CRLF]
[CRLF]

By way of further example, the DNT header currently accepts three values: 1—the user does not want to be tracked; 0—the user consents to being tracked; and null if the user has no preference. Therefore, the system 100 can determine the at least one activation based, at least in part, on a user setting DNT to “1” (e.g., “DNT: 1”) or on DNT being set to “1” by default (e.g., in Internet Explorer 9).

In one or more embodiments, the system 100 causes, at least one removal of the non-respective fields of the at least one browser (i.e., the one or more fields not required for a given transaction). In this example use case, the non-respective one or more fields include, at least in part, the following HTTP header fields:

GET / HTTP/1.1[CRLF]
Host: news.bbc.co.uk[CRLF]
Connection: close[CRLF]
DNT: 1[CRLF]
User-Agent: Web-sniffer/1.0.41 (+http://web-sniffer.net/)[CRLF]

In one embodiment, the system 100 causes, at least in part, one or more modifications of one or more respective one or more fields based, at least in part, on one or more amounts of information, one or more types of information, or a combination thereof associated with the identification of the at least one web browser. By way of example, the system 100 may cause, at least in part, at least one restriction of the information being presented via the HTTP header fields and/or enable at least one quantification of such restrictions. By way of further example, the type of information may include, at least in part, the one or more unique features or identifiers that provide a “fingerprint” for a web browser (e.g., ETags, User-Agent, HTTP_ACCEPT headers, browser plugin details, time zone, screen size and color depth, system fonts, are cookies enabled, limited supercookie test, etc.).

In one embodiment, the system 100 causes, at least in part, the one or more modifications based, at least in part, on one or more requirements, the at least one activation, or a combination thereof. By way of example, ordinarily there is no link between HTTP header generation in the at least one web browser and the DNT setting. However, it is contemplated that the system 100 can implement this link either as a filter between the browser and a network socket, which modifies the headers as required and/or as part of the basic functionality of one more application programming interfaces (APIs) associated with the at least one browser. More specifically, in one embodiment, the one or more restrictive modifications may include, at least in part, at least one obfuscation and/or abstraction of one or more of the respective one or more fields (e.g., hiding or generalizing values of the User-Agent string); at least one standardization of one or more of the respective one or more fields based, at least in part, on at least one default standard set of headers (e.g., HTTP headers identified by the Internet Engineering Task Force (IETF) in Request for Comments (RFC) 2616); and/or at least one regeneration of one or more of the respective one or more fields based, at least in part, on one or more hashing parameters, one or more encryption parameters, or a combination thereof. In particular, it is contemplated that the one or more restrictive modifications may reduce the overall entropy of the relevant HTTP headers and, therefore, inhibit the ability of third parties (e.g., commercial parties) to track the at least one web browser. Alternatively, in one embodiment, as discussed more fully below, the system 100 may cause, at least in part, one or more additive modifications of one or more of the respective one or more fields. For example, the system 100 may cause, at least in part, an association of a counter value with one or more regenerated fields. Further, in one embodiment, rather than cause, at least in part, the at least one removal of the non-respective one or more fields, the system 100 can cause, at least in part, one or more individual modifications of the non-respective one or more fields to increase the entropy of a field's content and thus also reduce the ability of third parties to track the at least one web browser.

In one embodiment, the system 100 can cause, at least in part, an obfuscation of the respective one or more fields, wherein the one or more modifications are based, at least in part, on the obfuscation. For example, the system 100 can cause, at least in part, an abstraction of the one or more example fields discussed above so that “User-Agent: Mozilla/5.0 (Macintosh; U; Intel Mac OS X; de-de) AppleWebKit/523.10.3 (KHTML, like Gecko) Version/3.0.4 Safari/523.10[CRLF]” becomes “User-Agent: Mozilla/5.0 [CRLF]”, for example. In another example use case, the system 100 can cause, at least in part, a removal of the one or more fields all together. As a result, the uniqueness of the at least one browser may be reduced by the system 100 from 1 of 2.5 million browsers, for example, to 20% of the browser population, for example. Moreover, it is contemplated that the system 100 can make similar reductions to one or more other fields (e.g., system fonts) to further obfuscate or generalize the one or more unique identifiers associated with the at least one web browser. However, it is also contemplated that the system 100 must balance the increase of anonymity with the fact that the one or more obfuscations or reductions may cause a server to misoptimize content on the at least one web browser (i.e., cause a degraded experience).

In one or more embodiments, the system 100 determines at least one standard for the at least one transmission of data. By way of example, the standard may include, at least in part, a known default standard set of headers, which will be consistent over all requests from a wide-range of web browsers (e.g., the HTTP headers identified in RFC 2616). In one embodiment, the system 100 can then cause, at least in part, a standardization of the respective one or more fields based, at least in part, on the at least one determined standard. Consequently, it is contemplated that a third-party would still be able to track the at least one browser, but now only at the level of a standard set of characteristics, thereby reducing the uniqueness (or increasing the entropy) of the at least one web browser.

In one embodiment, the system 100 can cause, at least in part, a regeneration of one or more of the respective one or more fields based, at least in part, on one or more hashing parameters, one or more encryption parameters, or a combination thereof, wherein the one or more modifications include, at least in part, the one or more regenerated fields. More specifically, the system 100 can process and/or facilitate a processing of the one or more fields according to various hashing, data encoding, and/or data encryption techniques to generate or regenerate a value for the identifying field. By way of example, if the system 100 determines one or more session numbers associated with the one or more fields are consistent across one or more HTTP calls (e.g., ETag: “686897696a7c876b7e”, “686897696a7c876b7e”, “686897696a7c876b7e”, etc.), then the system 100 may modify the one or more session numbers and/or the one or more fields in some random or non-predictable manner with high entropy (e.g., based on a hash table on a client) in a manner analogous to processes associated with a regenerable identifier (RI). In one example use case, the system 100 can execute the following example generation function: “generateRI( ): void->UUID4”, which will produce the following regenerable identifiers upon multiple calls:

generateRI( )
eaf8de17-00ab-43db-97f6-9f96f5c1bb6e
genreateRI( )
14c4ebd4-f3a9-4dd9-bece-c2dd83bce137

In this example use case, the use of “UUID4” as the identifier is solely for the sake of explanation. Moreover, rather than regenerating the identifier “eaf8de17-00ab-43 db-97f6-9f96f5c1bb6e”, for example, the system 100 would regenerate the example ETag value “686897696a7c876b7e”, for example. In another example use case, the system 100 causes, at least in part, a regeneration of one or more values of the User-Agent string such that the first User-Agent string in one session identifies the at least one web browser as Mozilla/5.0 (Windows 7), but 30 minutes later in the same session may identify the at least one web browser as Mozilla/4.0 (Unix), and so forth. As a result, it is contemplated that the analytical analysis or “tracking” of the one or more fields by a third-party would be limited to the period between regenerations (e.g., 30 minutes, one day, one week, etc.). More specifically, the regeneration time quantum (i.e., the amount of time a RI is valid) provides the upper limited for “syntactical” tracking of that identifier.

In one embodiment, the system 100 can cause, at least in part, at least one concatenation of the respective one or more fields based, at least in part, on at least one data structure (e.g., forming a structured RI (SRI)). By way of example, without the concatenation of the respective one or more fields, it is contemplated that the identifier may be passed along in a static or unstructured form, making it susceptible to being linked by a third-party to the user device through analysis, inference, etc. More specifically, the one or more fields (e.g., application ID, device ID, session ID, etc.) are structured to maintain values in accordance with the needs and requirements of the calling application (e.g., a web browser). In one example use case, the data structure can also include, at least in part, a browser, a platform, a release version, etc. Moreover, it is contemplated that the structure enables the system 100 to maintain fine-grain control over how the various fields of the identifiers are modified and/or the pace at which the identifiers are updated (e.g., every 30 minutes, day, week, etc.).

In one embodiment, the system 100 determines a counter value based, at least in part, on one or more numerical values (e.g., sequential and non-sequential values), one or more arguments (e.g., a string such as “a”, “b”, “n”, etc.), or a combination thereof. As previously discussed, from an analytics point of view (e.g., from the server side) when the system 100 determines the implementation of an RI (e.g., an ETag or Agent-Client string), the system 100 is unable to determine the previous identifier (i.e., the RI exhibits the characteristics of an anonymous identifier). Moreover, there is no mechanism for recording or communicating the number of times the RI has been regenerated. Therefore, in one embodiment, the system 100 can also cause, at least in part, an association of the counter value with the one or more regenerated fields, the one or more concatenated fields, or a combination thereof. More specifically, the system 100 can transform one or more of the respective one or more regenerated fields into one or more countable RIs (CRIs) having an example structure “struct CRI{ID×Count}”. For example, if the system 100 executes the following example generation function: “generateCRI( ): void->CRI”, the system 100 will produce the following regenerable identifiers upon multiple calls:

generateCRI( )
7d389333-ddf4-488e-a129-28c685099992-1
generateCRI( )
7c008f57-fb95-4b73-a516-eaf12ff0f5dc-2
generateCRI( )
f418b51e-5de8-41af-8717-1d8c26dda7bd-3

In this example use case, the numbers “1”, “2”, and “3” represent the counter values. As previously discussed, rather than associating the counter with the identifier “7d389333-ddf4-488e-a129-28c685099992”, for example, it is contemplated that the system 100 would associate the one or more counter values with an analogous regeneration of the example ETag value “686897696a7c876b7e”, for example. Similarly, in another example use case, the system 100 can determine to incorporate one or more non-consecutive counter values with the one or more regenerated fields or identifiers. For example, the counter value may be reset after “x” number of regenerations and/or the counter can also utilize “non-sequential numbering,” which may be facilitated by a one-time pad or one or more other mechanisms for generating both guessable and non-guessable non-sequential numbers. In particular, if the system 100 incorporates the following example reset function: “resetCRI( ): void->void” along with the previous example generation function: “generateCRI( ): void->CRI”, then the system 100 will produce the following countable regenerable identifiers upon multiple calls:

generateCRI( )
a7789731-f1cd-4af4-a6f1-f05cd80db653-1
generateCRI( )
c3ed0a71-6bfa-4f11-b884-c93ddd3fb386-2
generateCRI( )
9aeb164c-cd4e-4d13-aeca-a15be50fda03-3
resetCRI( )
generateCRI( )
f4b32593-1ade-41dc-b7c6-05bed3b6ef9b-1
generateCRI( )
3a3a99c9-fc66-4019-b3ac-4dcc6ecb5cd2-2

Further, in one embodiment, the system 100 can cause, at least in part, a modification of the “generateCRI( )” and “resetCRI( )” functions to accept an argument (e.g., a string) to hold a number of CRIs. As a result, in one example use case, the system 100 will produce the following multiple regenerable identifiers upon multiple calls:

generateCRI(”a”)
13435293-f1f6-4e30-bf04-7c929229c860-1
generateCRI(”a”)
7c56d0e9-e0dd-49a3-bd3f-3ed8a119bea7-2
generateCRI(”b”)
268c471a-5a4c-44d6-beb4-339c9875b4b7-1
generateCRI(”b”)
92d23320-5e26-4d0d-9c92-4ef6570266ce-2
resetCRI(”a”)
generateCRI(”a”)
9ebf4a29-5e7e-4f57-9267-056d0c030adc-1
generateCRI(”b”)
4da85544-4ee5-4c9f-8069-cf3f4a837d42-3

Again, as previous discussed, it is contemplated that rather than associating the counter with the identifier “1343529341f6-4e30-bf04-7c929229c860”, for example, the system 100 would incorporate the counter value with an analogous regeneration of the example ETag value “686897696a7c876b7e”, for example.

In addition, in one or more embodiments, the system 100 can cause, at least in part, an association of the at least one counter value with the respective one or more fields of the at least one concatenated fields (i.e., each field has its own counter), the at least one concatenated fields (i.e., the structure have their own counter), or a combination thereof (i.e., all of the fields and the structure itself have its own counter). More specifically, in the first case, the system 100 treats each field (e.g., “Mozilla/5.0”) as an individual RI and proceeds as previously discussed. The syntax of the CSRI is simply: “struct{POW(CRI)}”. In contrast, in the second case, the system 100 treats the whole SRI as an individual RI and the syntax is “struct{SRI×Count}”. Consequently, the syntax of the third case, the countable SRI (CSRI) is “struct{POW(CRI)×Count}”.

In one embodiment, the system 100 can cause, at least in part, at least one encryption of the at least one counter value based, at least in part, on a key, an encryption function, or a combination thereof. By way of example, the system 100 can extend a generation function (e.g., “generateCRI( )”) with encryption or other facilities to hide the value of the counter (e.g., by encrypting the counter using a public key, which can only be decrypted by a suitable function and a private key found elsewhere). In one example use case, the syntax of the example encryption function is “generate CRI(key): “string->CRI, decrypt (key,CRI)->CRI”. In particular, if the system 100 executes the following example generation function: “generateCRI( ): void->CRI”, then the system 100 will produce the following CRIs upon multiple calls:

generateCRI( ”12345” )
7d389333-ddf4-488e-a129-28c685099992-8973598
generateCRI( ”12345” )
7c008f57-fb95-4b73-a516-eaf12ff0f5dc-2-2348976
generateCRI( ”12345” )
f418b51e-5de8-41af-8717-1d8c26dda7bd-3-234987
decryptCRI(”12345”, 7d389333-ddf4-488e-a129-28c685099992-8973598)
7d389333-ddf4-488e-a129-28c685099992-8973598-1
decryptCRI( ”12345”, 7c008f57-fb95-4b73-a516-eaf12ff0f5dc-2-2348976
)
7c008f57-fb95-4b73-a516-eaf12ff0f5dc-2-2
decryptCRI( ”12345”,
f418b51e-5de8-41af-8717-1d8c26dda7bd-3-234987)
f418b51e-5de8-41af-8717-1d8c26dda7bd-3-3

Moreover, the system 100 can further extend the generate CRI functions to accept an encryption function rather than just a key. Further, the system 100 can also generate encrypted forms of the multiple CRI versions as previously discussed.

In one embodiment, the system 100 causes, at least in part, at least one transmission of data associated with the at least one browser (e.g., an HTTP call) based, at least in part, on the one or more modified fields (e.g., a regenerated User-Agent string). As a result, the ability of third parties (e.g., commercial parties) to track a user's web browser is limited while at the same time, a non-profit organization, for example, can determine additional statistical inferences from the identifiers to improve overall user experience.

By way of example way of example, the UEs 101, modification platform 103, the modification manager 107, the applications 109, the identifiers database 111, the services platform 113, the services 115, and the content providers 117 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

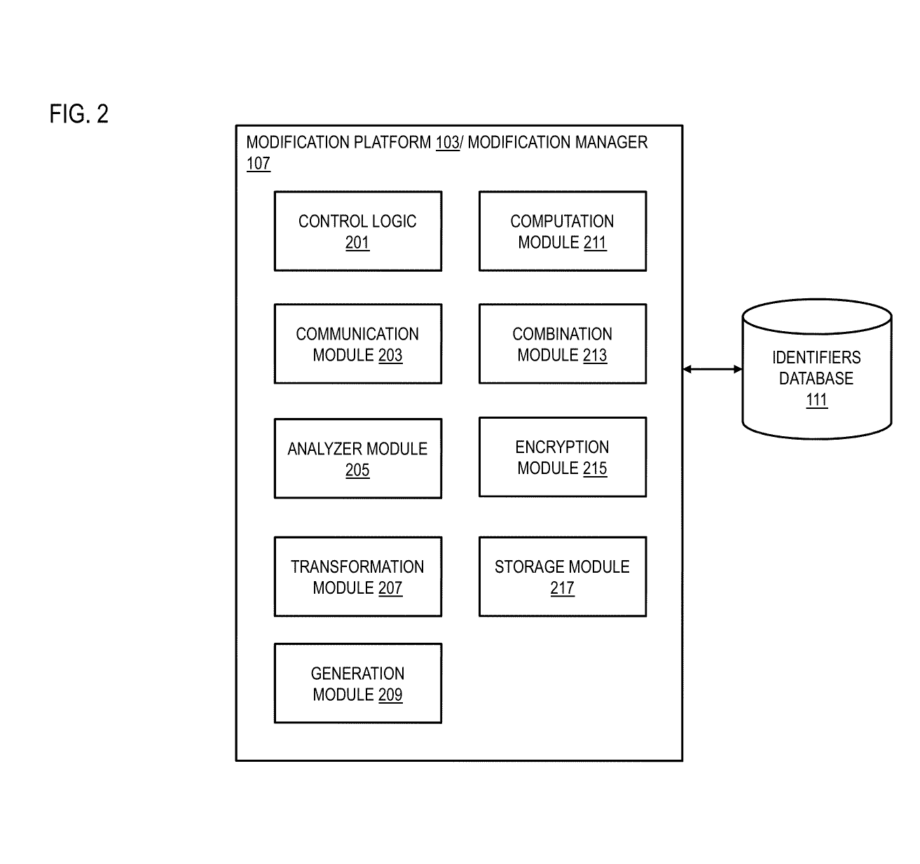

FIG. 2 is a diagram of the components of a modification platform 103/modification manager 107, according to one embodiment. Again, while the modification platform 103 and the modification manager 107 are interchangeable, the various embodiments of the present invention disclosed herein mainly reference the modification manager 107 for the sake of explanation. By way of example, the modification manager 107 includes one or more components for providing modifying unique identifiers and/or analyzing regenerated identifiers. It is contemplated that the functions of these components may be combined in one or more components or performed by other components of equivalent functionality. In this embodiment, the modification manager 107 includes a control logic 201, a communication module 203, an analyzer module 205, a transformation module 207, a generation module 209, a computation module 211, a combination module 213, an encryption module 215, and a storage module 217.

The control logic 201 oversees tasks, including tasks performed by the communication module 203, the analyzer module 205, the transformation module 207, the generation module 209, the computation module 211, the combination module 213, the encryption module 215, and the storage module 217. For example, although the other modules may perform the actual task, the control logic 201 may determine when and how those tasks are performed or otherwise direct the other modules to perform the task.

In one embodiment, the communication module 203 is used to for communication between the UEs 101, the modification platform 103, the modification manager 107, the applications 109, the identifiers database 111, the services platform 113, the services 115, and the content providers 117. The communication module 203 may also be used to communicate commands, requests, data, etc. The communication module 203 also may be used to cause, at least in part, at least one transmission of data associated with the at least one web browser (e.g., an HTTP call) based, at least in part, on the one or more modified fields (e.g., a regenerated User-Agent string).

The analyzer module 205, in certain embodiments, is used to determine one or more fields associated with an identification of at least one web browser. By way of example, the one or more fields may be inferred by the analyzer module 205 based, at least in part, on the content from one or more simple, static HTTP requests. The analyzer module 205, in connection with the communication module 203, may also be used to determine the respective one or more fields based, at least in part, on the one or more requirements associated with the at least one transmission of data (e.g., a HTTP call or request), at least one activation of the DNT field (e.g., “DNT: 1”), or a combination thereof. The analyzer module 205, also in connection with the communication module 203 and/or the storage module 217, may be further used to determine at least one standard for the at least one of transformation of data (e.g., the standard headers enumerated in RFC 2616).

In one embodiment, the transformation module 207 is used to cause, at least in part, at least one removal of the non-respective one or more fields based, at least in part, on the one or more requirements associated with the at least one transmission. By way of example, the one or more non-respective fields may include “Host: news.bbc.co.uk[CRLF]”, for example. The transformation module 207 may also be used to cause, at least in part, one or more modifications of respective ones of the one or more fields based, at least in part, on one or more amounts of information, one or more types of information, or a combination thereof associated with the identification of the at least one web browser (e.g., ETags, User-Agent, HTTP_ACCEPT headers, browser plugin details, time zone, screen size and color depth, system fonts, are cookies enabled, limited supercookie test, etc.). By way of example, the one or more modifications may include, at least in part, at least one restriction of information being presented via the HTTP header fields and/or an association of a counter value with one or more of the respective one or more fields to enable a quantitative assessment of such information. The transformation module 207 also may be used to cause, at least in part, the one or more modifications based, at least in part, on the one or more requirements, the at least one activation, or a combination thereof. By way of example, when a user sets “DNT: 1”, the transformation module 207 also may be used to cause, at least in part, at least one removal of the non-respective one or more fields based, at least in part, on one or more requirements associated with the at least one transmission of data. The transformation module 207 may also be used to cause, at least in part, at least one obfuscation, at least one abstraction, and/or at least one standardization of the respective one or more fields to reduce the overall entropy of the one or more HTTP headers. As previously discussed, in certain embodiments, rather than remove the non-respective one or more fields, the transformation module 207 can also cause, at least in part, one or more individual modifications of the non-respective one or more fields to increase the entropy of the field's content and thus reduce the ability of third parties to track the at least one web browser. The transformation module 207 also may be used to cause, at least in part, at least one concatenation of the respective one or more fields based, at least in part, on the at least one data structure (e.g., a User-Agent string).

The generation module 209, in certain embodiments, is used to cause, at least in part, a regeneration of the respective one or more fields based, at least in part, on one or more hashing parameters, one or more encryption parameters, or a combination thereof. By way of example, the generation module 209 can regenerate one or more identifiers associated with the at least one web browser (e.g., ETags, User-Agent strings, etc.), one or more countable regenerable identifiers (e.g., an ETag value associated with a counter), one or more countable structured regenerable identifiers, or a combination thereof. More specifically, the generation module 209 can generate the one or more RIs using the example function “generateRI( ): void->UUID4. Moreover, the generation module 209 can generate the one or more countable regenerable identifiers using the example function “generateCRI( ): void->CRI” and “resetCRI( ): void->void”. Further, the generation module 209 can generate the one or more countable structured regenerable identifiers using the example functions “struct{POW(CRI)}”, “struct{SRI×Count}”, and “{POW(CRI)×Count} depending on whether the generation module 209 intends each field to behave as an individual RI, the whole SRI to behave an individual RI, or a combination thereof, respectively.

In one embodiment, the computation module 211 is used to determine a counter value based, at least in part, on one or more numerical values (e.g., sequential or non-sequential numbers), one or more arguments (e.g., a string), or a combination thereof. In one embodiment, the combination module 213 is used to cause, at least in part, an association of the counter value with the one or more regenerated fields, the one or more concatenated fields, or a combination thereof. In particular, the counter value provides a mechanism for enabling the modification manager 107 to determine the number of times (or rate) by which the one or more identifiers are regenerated by a user. More specifically, the combination module 213 can cause, at least in part, the one or more regenerated fields to have its own counter value, the at least one concatenated fields to have its own counter, or a combination thereof (i.e., all of the fields and the structure have their own counter).

The encryption module 215, in certain embodiments, is used to cause, at least in part, at least one encryption of the at least one counter value based, at least in part, on a key, an encryption function, or a combination thereof. In particular, the encryption module 215, in connection with the generation module 209 and the computation module 211, can cause, at least in part, the hiding of the counter value (e.g., by encrypting the counter using a public key which can only be decrypted by a suitable function and a private key found elsewhere. In one embodiment, the storage module 217 is used to manage the storage of one or more standard sets of headers (e.g., standard headers enumerated in RFC 2616), one or more hashing parameters, one or encryption parameters, one or more counting parameters, or a combination thereof.

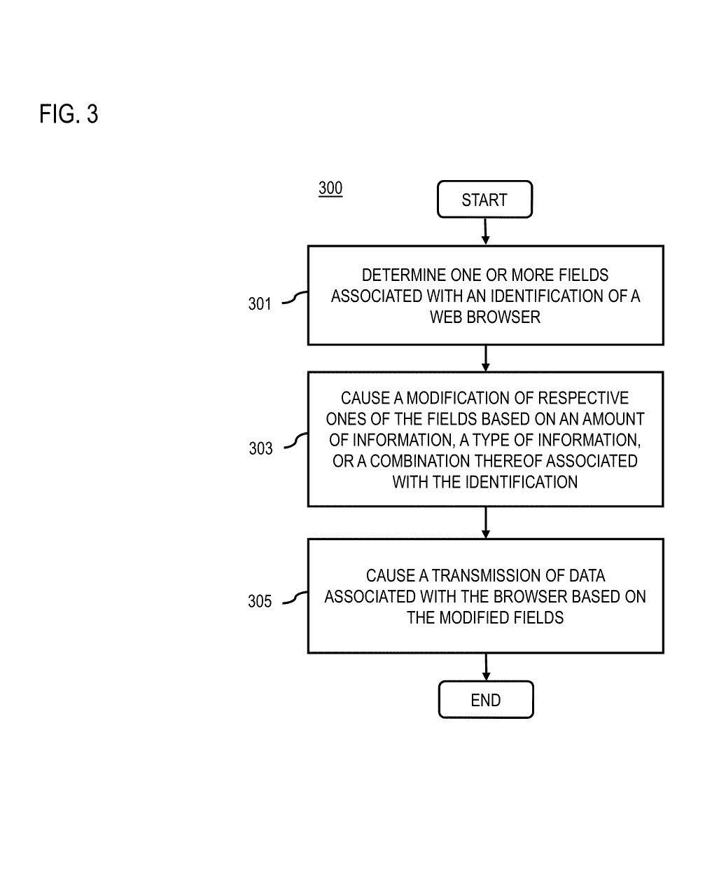

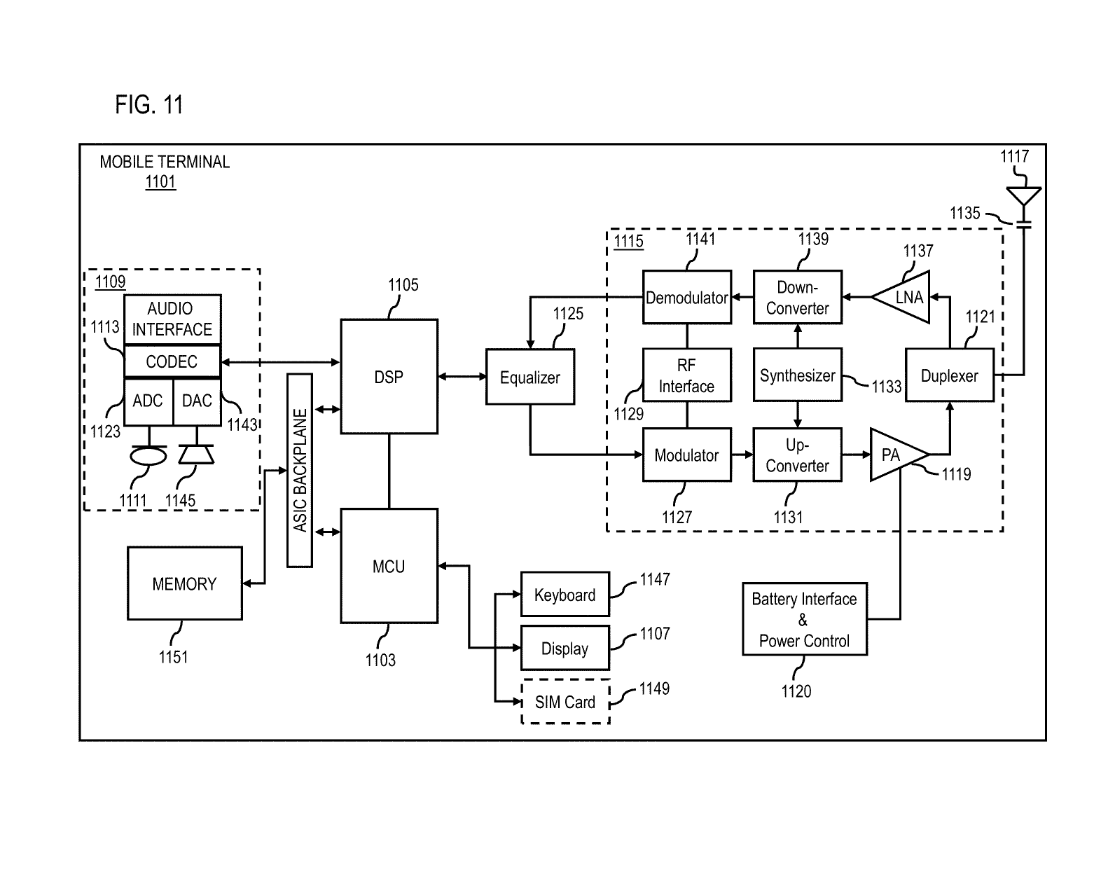

FIGS. 3-5 are flowcharts of processes for modifying unique identifiers and/or analyzing regenerated identifiers, according to one embodiment. In one embodiment, the modification platform 103/modification manager 107 performs the process 300 and is implemented in, for instance, a chip set including a processor and a memory as shown in FIG. 11. In step 301, the modification manager 107 determines one or more fields associated with an identification of at least one web browser. By way of example, the one or more fields include, at least in part, one or more HTTP headers associated with at least one transmission of data (e.g., an HTTP call), the at least one web browser, or a combination thereof. For example, a typical set of headers and information may include, at least in part, the following:

GET / HTTP/1.1[CRLF]
Host: news.bbc.co.uk[CRLF]
Connection: close[CRLF]
DNT: 1[CRLF]
User-Agent: Web-sniffer/1.0.41 (+http://web-sniffer.net/)[CRLF]
Accept-Encoding: gzip[CRLF]
Accept-Charset: ISO-8859-1,UTF-8;q=0.7,*;q=0.7[CRLF]
Cache-Control: no-cache[CRLF]
Accept-Language: de,en;q=0.7,en-us;q=0.3[CRLF]
Referer: http://web-sniffer.net/[CRLF]
[CRLF]

In step 303, the modification manager 107 causes, at least in part, one or more modifications of respective ones of the one or more fields based, at least in part, on one or more amounts of information, one or more types of information, or a combination thereof associated with the identification. By way of example, the respective one or more fields include, at least in part, one or more fields required for a given transaction (e.g., HTTP header fields), which in the previously discussed example include, at least in part, the following:

Accept-Encoding: gzip[CRLF]
Accept-Charset: ISO-8859-1,UTF-8;q=0.7,*;q=0.7[CRLF]
Cache-Control: no-cache[CRLF]
Accept-Language: de,en;q=0.7,en-us;q=0.3[CRLF]
Referer: http://web-sniffer.net/[CRLF]
[CRLF]

By way of further example, the one or more modifications may include, at least in part, at least one restriction by the modification manager 107 of the information being presented via the HTTP header fields and/or at least one association by the modification manager 107 of a counter value with one or more of the respective one or more fields to enable a quantitative assessment of such information. In addition, the type of information may include, for example, the one or more or identifiers that provide a “fingerprint” for a web browser (e.g., ETags, User-Agent, HTTP_ACCEPT headers, browser plugin details, time zone, screen size and color depth, system fonts, are cookies enabled, limited supercookie test, etc.).

In step 305, the modification manager 107 causes, at least in part, at least one transmission of data associated with the at least one web browser based, at least in part, on the one or more modified fields. As previously discussed, the one or more modified fields can include, at least in part, one or more removed fields, one or more regenerated fields, one or more obfuscated fields, one or more standardized fields, and/or one or more of the respective one or more fields associated with a counter value. In particular, it is contemplated that transmitting the one or more modified fields in response to a request limits the ability of third parties to track a user's web browser while at the same time potentially enabling additional statistical inferences to be made from the one or more fields (e.g., by a non-profit organization).

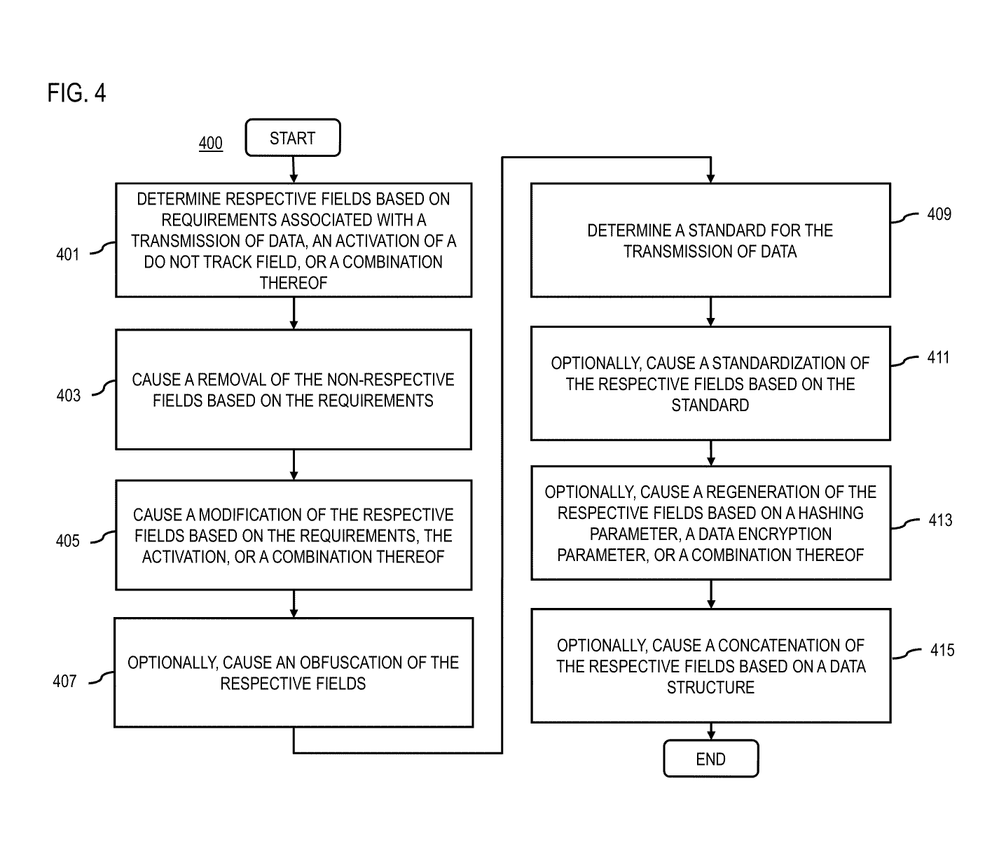

FIG. 4 depicts a process 400 of modifying one or more fields associated with the identification of the at least one web browser (e.g., Etag values, HTTP headers, etc.). In one embodiment, the modification platform 103/modification manager 107 performs the process 400 and is implemented in, for instance, a chip set including a processor and a memory as shown in FIG. 11. In step 401, the modification manager 107 determines the respective one or more fields based, at least in part, on one or more requirements associated with the at least one transmission of data, at least one activation of a Do Not Track field, or a combination thereof. By way of example, in the previously discussed example use case, the one or more fields required for the at least one transmission include, at least in part, the following HTTP header fields:

Accept-Encoding: gzip[CRLF]
Accept-Charset: ISO-8859-1,UTF-8;q=0.7,*;q=0.7[CRLF]
Cache-Control: no-cache[CRLF]
Accept-Language: de,en;q=0.7,en-us;q=0.3[CRLF]
Referer: http://web-sniffer.net/[CRLF]
[CRLF]

As previously discussed, the DNT header currently accepts three values: 1—the user does not want to be tracked; 0—the user consents to being tracked; and null if the user has no preference. Therefore, the modification manager 107 can determine the at least one activation based, at least in part, on a user setting DNT to “1” (e.g., “DNT: 1”) or on the DNT header being set to “1” by default (e.g., in Internet Explorer 9).

In step 403, the modification manager 107 causes, at least in part, at least one removal of the non-respective one or more fields based, at least in part, on the one or more requirements associated with the at least one transmission of data. By way of example, when the modification manager 107 determines “DNT: 1”, the modification manager 107 can remove all HTTP fields that are not required for a given transaction (e.g., a HTTP call). For example, in the example use case discussed above, the modification manager 107 may remove the following HTTP header fields:

GET / HTTP/1.1[CRLF]
Host: news.bbc.co.uk[CRLF]
Connection: close[CRLF]
DNT: 1[CRLF]
User-Agent: Web-sniffer/1.0.41 (+http://web-sniffer.net/)[CRLF]

However, as previously discussed, in certain embodiments, rather than removing the non-respective one or more fields, the modification manager 107 can individually modify the non-respective one or more fields (e.g., User-Agent) to increase the entropy (i.e., randomness) of the field's content.

In step 405, the modification manager 107 causes, at least in part, the one or more modifications based, at least in part, on the one or more requirements, the at least one activation, or a combination thereof. By way of example, ordinarily there is no link between HTTP header generation in the at least one web browser and the DNT setting. However, it is contemplated that the modification manager 107 can implement this link either as a filter between the browser and a network socket, which modifies the headers as required and/or as part of the basic functionality of the one or more APIs associated with the at least one browser. Moreover, as previously discussed, in one embodiment, the one or more modifications may include, at least in part, at least one restriction by the modification manager 107 of the information being presented via the HTTP header fields and/or at least one association of a counter value with the one or more regenerated fields to enable a quantitative assessment of the restricted information. More specifically, in one embodiment, the one or more the one or more restrictive modifications may include, at least in part, at least one obfuscation and/or abstraction of one or more of the respective one or more fields (e.g., hiding or generalizing values of the User-Agent string); at least one standardization of one or more of the respective one or more fields based, at least in part, on at least one default standard set of headers (e.g., HTTP headers enumerated in RFC 2616); and/or at least one regeneration of one or more of the respective one or more fields based, at least in part, on one or more hashing parameters, one or more encryption parameters, or a combination thereof.

In step 407, the modification manager 107 optionally causes, at least in part, at least one obfuscation of the respective one or more fields, wherein the one or more modifications are based, at least in part, on the obfuscation. For example, the modification manager 107 can cause, at least in part, an abstraction of the one or more fields discussed above so that “User-Agent: Mozilla/5.0 (Macintosh; U; Intel Mac OS X; de-de) AppleWebKit/523.10.3 (KHTML, like Gecko) Version/3.0.4 Safari/523.10[CRLF]” becomes “User-Agent: Mozilla/5.0 [CRLF]” or “User-Agent: Mozilla [CRLF], for example. In another example use case, the modification manager 107 can cause, at least in part, the removal of the one or more fields all together. Moreover, it is contemplated that the modification manager 107 can cause, at least in part, similar reductions to one or more other fields (e.g., system fonts) to further obfuscate or generalize the one or more unique identifiers associated with the at least one web browser.

In step 409, the modification manager 107 determines at least one standard for the at least one transmission of data. By way of example, the standard may include, at least in part, a known default standard set of headers, which will be consistent over all requests from a wide-range of web browsers (e.g., the standard HTTP headers enumerated in RFC 2616). Then, in step 411, the modification manager 107 optionally causes, at least in part, at least one standardization of the respective one or more fields based, at least in part, on the at least one standard, wherein the one or more modifications are based, at least in part, on the standardization. As a result, it is contemplated that a third-party would still be able to track the at least one browser, but now only at the level of a standard set of characteristics, thereby reducing the uniqueness (or increasing the entropy) of the at least one web browser.

In step 413, the modification manager 107 optionally causes, at least in part, at least one regeneration of the respective one or more fields based, at least in part, on one or more hashing parameters, one or more data encryption parameters, or a combination thereof, wherein the one or more modifications include, at least in part, the one or more regenerated fields. More specifically, the modification manager 107 can process and/or facilitate a processing of the one or more fields according to various hashing, data encoding and/or data encryption techniques to generate or regenerate one or more values for the one or more identifying fields (e.g., an ETag, a User-Agent string, etc.). By way of example, if the modification manager 107 determines that one or more session numbers associated with the one or more fields are consistent across one or more HTTP calls (e.g., ETag: “686897696a7c876b7e”, “686897696a7c876b7e”, “686897696a7c876b7e”, etc.), then the modification manager 107 may modify the one or more session numbers and/or the one or more fields in some random or non-predictable manner with high entropy in a manner analogous to the processes associated with an RI. More specifically, in one example use case, the modification manager 107 can execute the following example generation function: “generateRI( ): void->UUID4”, which will produce the following regenerable identifiers upon multiple calls:

generateRI( )
eaf8de17-00ab-43db-97f6-9f96f5c1bb6e
genreateRI( )
14c4ebd4-f3a9-4dd9-bece-c2dd83bce137

In this example use case, rather than regenerating the identifier “eaf8de17-00ab-43 db-97f6-9f96f5c1bb6e”, for example, the modification manager 107 would generate the example ETag value “686897696a7c876b7e”, for example. In another example use case, the modification manager 107 can regenerate the one or more values of the User-Agent string.

In step 415, the modification manager 107 optionally causes, at least in part, at least one concatenation of the respective one or more fields based, at least in part, on at least one data structure, wherein the one or more modifications, the at least one regeneration, or a combination thereof is based, at least in part, on the at least one concatenated fields. In one embodiment, the one or more fields (e.g., application ID, device ID, session ID, etc.) are structured to maintain values in accordance with the needs and requirements of the calling application (e.g., a web browser). By way of example, the data structure may include, at least in part, a browser, a platform, a release version, etc. Moreover, it is contemplated that the structure enables the modification manager 107 to maintain fine-grain control over how the various fields of the identifiers are modified and/or the pace at which the identifiers are.

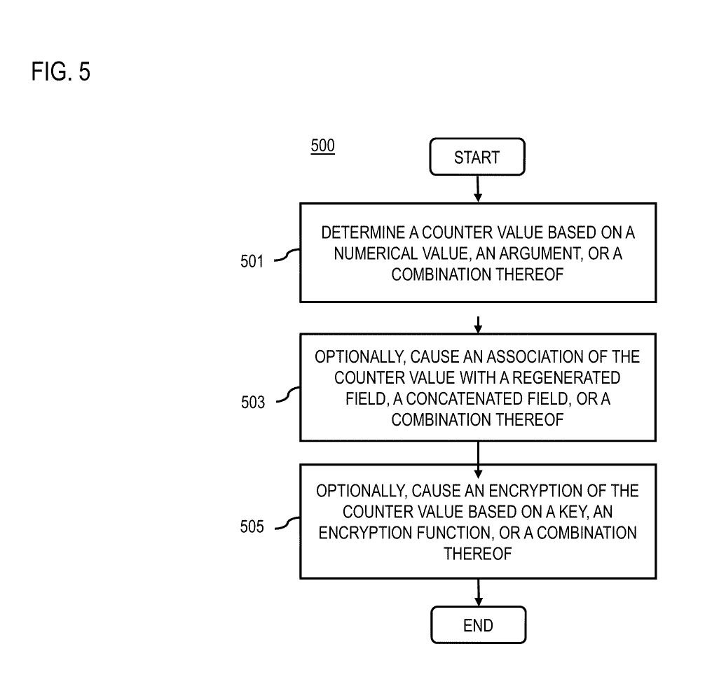

FIG. 5 depicts a process 500 of associating a counter value with one or more regenerated fields (e.g., Etag values, HTTP headers, etc.). In one embodiment, the modification platform 103/modification manager 107 performs the process 500 and is implemented in, for instance, a chip set including a processor and a memory as shown in FIG. 11. In step 501, the modification manager determines a counter value based, at least in part, on one or more numerical values, one or more arguments, or a combination thereof. By way of example, the counter value may include one or more numerical values (e.g., sequential and non-sequential values), one or more arguments (e.g., a string such as “a”, “b”, “n”, etc.), or a combination thereof.

In step 503, the modification manager 107 optionally causes, at least in part, an association of the counter value with the one or more regenerated fields, the one or more concatenated fields, or a combination thereof. By way of example, the CRI has an example structure “struct CRI{ID×Count}”. In particular, if the modification manager 107 executes the following example generation function: “generateCRI( ): void->CRI”, the modification manager 107 will produce the following regenerable identifiers upon multiple calls:

generateCRI( )
7d389333-ddf4-488e-a129-28c685099992-1
generateCRI( )
7c008f57-fb95-4b73-a516-eaf12ff0f5dc-2
generateCRI( )
f418b51e-5de8-41af-8717-1d8c26dda7bd-3

As previously discussed, the numbers “1”, “2”, and “3” represent the counter values. Moreover, rather than associating the counter with the identifier “7d389333-ddf4-488e-a129-28c685099992”, for example, it is contemplated that the modification manager 107 would associate the one or more counter values with an analogous regeneration of the example ETag value “686897696a7c876b7e”, for example. Likewise, in another example use case, the modification manager 107 can determine to associate non-consecutive counter values with the regenerated identifier. More specifically, if the modification manager 107 incorporates the following example reset function: “generateCRI( ): void->CRI”, then the modification manager 107 will produce the following CRIs upon multiple calls:

generateCRI( )
a7789731-f1cd-4af4-a6f1-f05cd80db653-1
generateCRI( )
c3ed0a71-6bfa-4f11-b884-c93ddd3fb386-2
generateCRI( )
9aeb164c-cd4e-4d13-aeca-a15be50fda03-3
resetCRI( )
generateCRI( )
f4b32593-1ade-41dc-b7c6-05bed3b6ef9b-1
generateCRI( )
3a3a99c9-fc66-4019-b3ac-4dcc6ecb5cd2-2

In addition, in one embodiment, the modification manager 107 can cause, at least in part, a modification of the “generateCRI( )” and “resetCRI( )” functions to accept an argument (e.g., a string) to hold a number of CRIs. As a result, in one example use case, the modification manager 107 will produce the following multiple regenerable identifiers upon multiple calls:

generateCRI(”a”)
13435293-f1f6-4e30-bf04-7c929229c860-1
generateCRI(”a”)
7c56d0e9-e0dd-49a3-bd3f-3ed8a119bea7-2
generateCRI(”b”)
268c471a-5a4c-44d6-beb4-339c9875b4b7-1
generateCRI(”b”)
92d23320-5e26-4d0d-9c92-4ef6570266ce-2
resetCRI(”a”)
generateCRI(”a”)
9ebf4a29-5e7e-4f57-9267-056d0c030adc-1
generateCRI(”b”)
4da85544-4ee5-4c9f-8069-cf3f4a837d42-3

Again, as previously discussed, it is contemplated that rather than associating the counter with the identifier “13435293-f1f6-4e30-bf04-7c929229c860”, for example, the modification manager 107 would associate the counter value with an analogous regeneration of the example ETag value “686897696a7c876b7e”, for example.

By way of further example, in one embodiment, the modification manager 107 can cause, at least in part, an association of a counter value with one or more of the respective one or more fields of the at least one concatenated fields (CSRI) (i.e., one counter per field). In another example use case, the modification manager 107 can cause, at least in part, an association of a counter value with the at least one concatenated fields (i.e., the concatenated field has its own counter). In a further example use case, the modification manager 107 can cause, at least in part, an association of a counter value with the respective one or more fields of the least one concatenated fields and the concatenated structure. More specifically, in the first instance, the modification manager 107 treats each field (e.g., “Mozilla/5.0”) as an individual RI and regeneration proceeds as previously discussed. Whereas, in the second instance, the modification manager 107 treats the whole SRI as an individual RI.

In step 505, the modification manager 107 optionally causes, at least in part, at least one encryption of the at least one counter value based, at least in part, on a key, an encryption function, or a combination thereof. By way of example, the modification manager 107 can extend the generation function (e.g., “generateCRI( )”) with encryption or other facilities to hide the value of the counter (e.g., by encrypting the counter using a public key, which can only be decrypted by a suitable function and a private key found elsewhere). In one example use case, the syntax of the encryption function is “generate CRI(key): “string->CRI, decrypt (key,CRI)->CRI”. More specifically, if the modification platform 103 executes the following example generation function: “generateCRI( ): void->CRI”, then the modification platform 103 will produce the following CRIs upon multiple calls:

generateCRI( ”12345” )
7d389333-ddf4-488e-a129-28c685099992-8973598
generateCRI( ”12345” )
7c008f57-fb95-4b73-a516-eaf12ff0f5dc-2-2348976
generateCRI( ”12345” )
f418b51e-5de8-41af-8717-1d8c26dda7bd-3-234987
decryptCRI(”12345”, 7d389333-ddf4-488e-a129-28c685099992-8973598)
7d389333-ddf4-488e-a129-28c685099992-8973598-1
decryptCRI( ”12345”, 7c008f57-fb95-4b73-a516-eaf12ff0f5dc-2-2348976
)
7c008f57-fb95-4b73-a516-eaf12ff0f5dc-2-2
decryptCRI( ”12345”,
f418b51e-5de8-41af-8717-1d8c26dda7bd-3-234987)
f418b51e-5de8-41af-8717-1d8c26dda7bd-3-3

Moreover, the modification manager 107 can further extend the generate CRI functions to accept an encryption function rather than just a key. Further, the modification manager 107 can also generate encrypted forms of the multiple CRI versions as previously discussed.

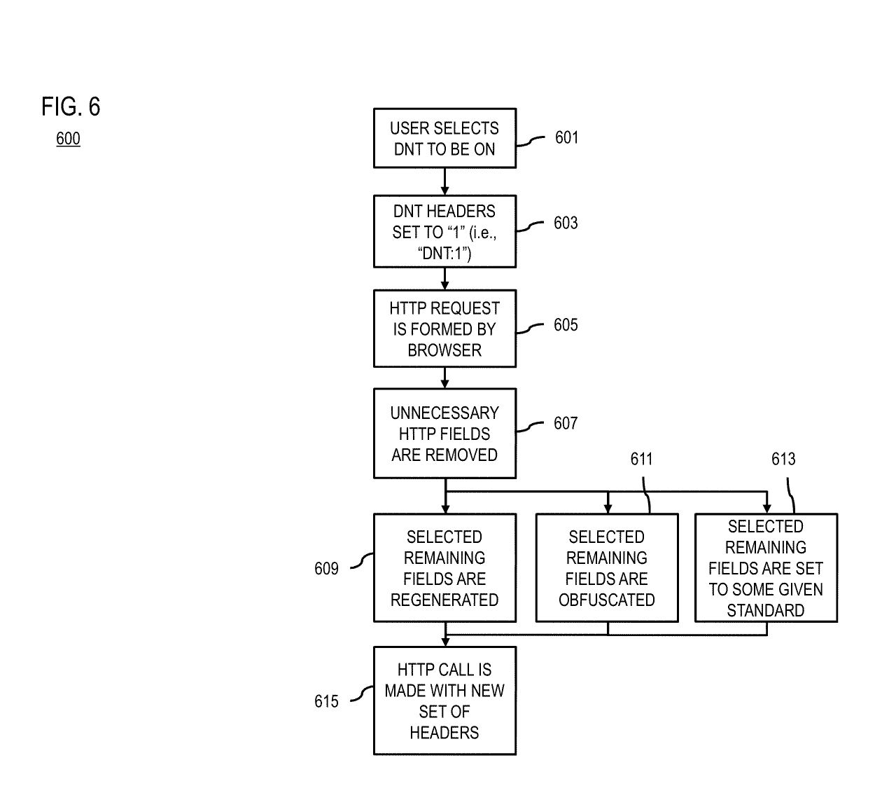

FIG. 6 is a diagram of a workflow for modifying unique identifiers associated with at least one web browser, according to one embodiment. By way of example, the workflow process 600 is applicable to a user transmitting a HTTP call via at least one web browser. In step 601, the system determines the activation of the DNT header associated with the at least one web browser. As previously discussed, the DNT header currently accepts three values: 1—the user does not want to be tracked; 0—the user consents to being tracked; and null if the user has no preference. In step 603, the system 100 determines that the user has set “DNT: 1” and, therefore, does not want his or her web browser to be tracked by third parties (e.g., analytical services, advertising services, social networking services, etc.). However, third-party compliance with DNT is based on an honor system and, therefore, not a guarantee that the Do Not Track policies will be implemented and/or enforced by all third parties. Moreover, even if DNT was universally implemented, third parties can still readily track a web browser's requests and transmissions to a server, for example, based, at least in part, on one or more unique identifiers or “fingerprints” associated with the web browser. In step 605, the system determines the formation of a HTTP request by the web browser (e.g., “get me the file ‘xyz.html’”).

In step 607, the system 100 causes, at least in part, at least one removal of the non-respective (i.e., unnecessary) one or more fields (e.g., HTTP fields). By way of example, in the example use case discussed above, the system 100 may remove the follow HTTP header fields:

GET / HTTP/1.1[CRLF]
Host: news.bbc.co.uk[CRLF]
Connection: close[CRLF]
DNT: 1[CRLF]
User-Agent: Web-sniffer/1.0.41 (+http://web-sniffer.net/)[CRLF]

However, as previously discussed, the system 100 can also modify the unnecessary fields (e.g., User-Agent) individually to increase the entropy of the content or the field. Therefore, in certain embodiments, the system 100 will not automatically discard all unnecessary HTTP fields. In steps 609, 611, and 613, the system 100 causes, at least in part, one or more optional modifications of respective ones of the one or more fields (e.g., HTTP headers fields that are required for a given transaction). More specifically, in step 609, the system causes, at least in part, at least one regeneration of one or more of the respective one or more fields based, at least in part, on one or more hashing parameters, one or more encryption parameters, or a combination thereof. By way of example, if the system 100 determines that one or more session numbers associated with the one or more fields are consistent across one or more HTTP calls (e.g., ETag: “686897696a7c876b7e”, “686897696a7c876b7e”, “686897696a7c876b7e”, etc.), then the system 100 may cause, at least in part, a modification of the one or more session numbers and/or one or more fields in some random or non-predictable manner with high entropy (e.g., based on a hash table on a client) in a manner analogous to the processes associated with a regenerable identifier. More specifically, in one example use case, the system 100 can execute the following example generation function: “generateRI( ): void->UUID4”, which will produce the following regenerable identifiers upon multiple calls:

generateRI( )
eaf8de17-00ab-43db-97f6-9f96f5c1bb6e
genreateRI( )
14c4ebd4-f3a9-4dd9-bece-c2dd83bce137

However, in this example use case, rather than regenerating the identifier “eaf8de17-00ab-43 db-97f6-9f96f5c1bb6e”, for example, the system 100 would regenerate the example ETag value “686897696a7c876b7e”, for example.

In step 611, the system 100 causes, at least in part, at least one obfuscation of the respective one or more fields, wherein the one or more modifications are based, at least in part, on the obfuscation. In addition to removing the one or more HTTP fields all together, the system 100 can obfuscate or abstract individual values of the one or more fields. By way of example, the system 100 can obfuscate or abstract the following User-Agent field: “User-Agent: Mozilla/5.0 (Macintosh; U; Intel Mac OS X; de-de) AppleWebKit/523.10.3 (KHTML, like Gecko) Version/3.0.4 Safari/523.10[CRLF]” down to “User-Agent: Mozilla/5.0 [CRLF]” and, therefore, greatly reducing the uniqueness of the User-Agent field. In step 613, the system 100 can cause, at least in part, at least one standardization of the respective one or more fields based, at least in part, on at least one standard (e.g., HTTP standards enumerated in RFC 2616), wherein the one or more modifications are based, at least in part, on the standardization. As a result, it is contemplated that a third-party would still be able to track the at least one web browser, but now only at the level of a standard set of characteristics. Then in step 615, the system 100 causes, at least in part, at least one transmission of data associated with the at least one browser (e.g., an HTTP call) based, at least in part, on the one or more modified fields.

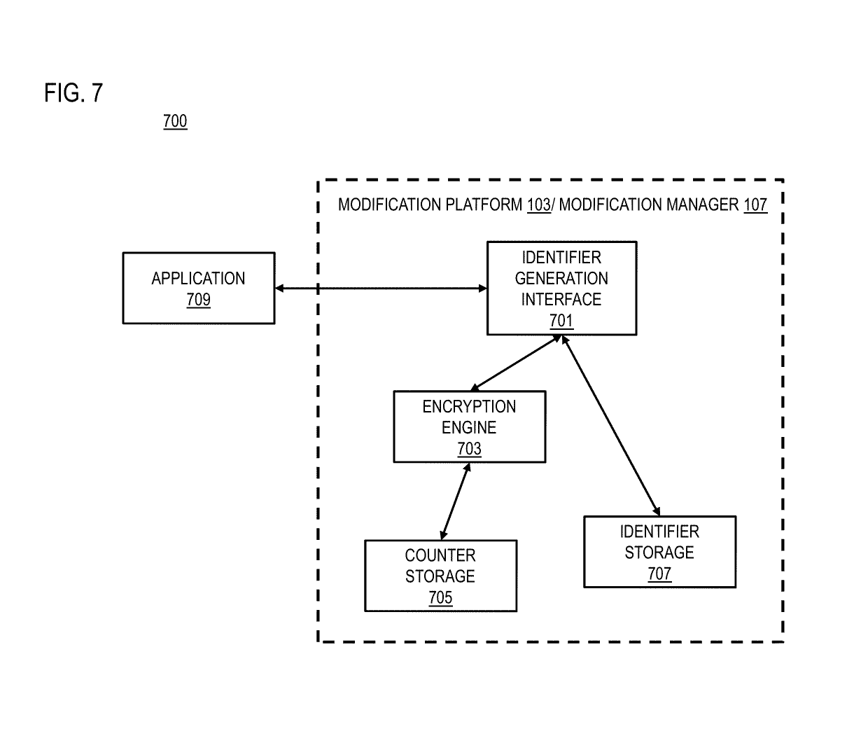

FIG. 7 is also a diagram of components of a modification platform 103/modification manager 107, according to one embodiment. By way of example, the modification manager 107 includes one or more components for generating regenerable identifiers. It is contemplated that the functions of these components may be combined in one or more components or performed by other components of equivalent functionality. In this embodiment, the modification manager 107 includes an identifier generation interface 701, an encryption engine 703, a counter storage 705, and an identifier storage 707. In addition, the identifier generation interface 701 is associated with an application 709 (e.g., a web browser) via a communication network (e.g., the communication network 105 (not shown for illustrative purposes)). More specifically, in one embodiment, the identifier interface 701 is used as an interface mechanism (e.g., hardware or more typically software based on APIs). The encryption engine 703, in certain embodiments, is used to manage the one or more encryption keys and the one or more encryption algorithms. Typically, if the identifier generation interface 701 consists of hardware, then the encryption engine 703 will also be hardware or will communicate with one or more external hardware acceleration components. In contrast, if the identifier generation interface 701 consists of software, then the encryption engine 703 will be programmable.

In one embodiment, the counter storage 705 is used to store the one or more counters that the modification manager 107 can associate with the one or more regenerated fields so that the number of times a RI and/or an SRI is regenerated (as well as frequency) can be determined. More specifically, the counter storage 705 includes, at least in part, a hash table that is implemented using any suitable database or information storage technology for the management of the one or more counters. The identifier storage 707, in certain embodiments, is used to store the one or more identifiers associated with the at least one web browser. More specifically, the identifier storage 707 includes, at least in part, a hash table implemented using any suitable database or information storage technology for the storage of multiple identifiers (e.g., Etags, User-Agent strings, etc.) and all related meta-information. Typically, the mapping between the counters and identifiers is made using some primary key if the one or more counters are related to the one or more identifiers. However, in some example use cases, the one or more counters may be global in nature and, therefore, a link between the one or more counters and the one or more identifiers are not required.

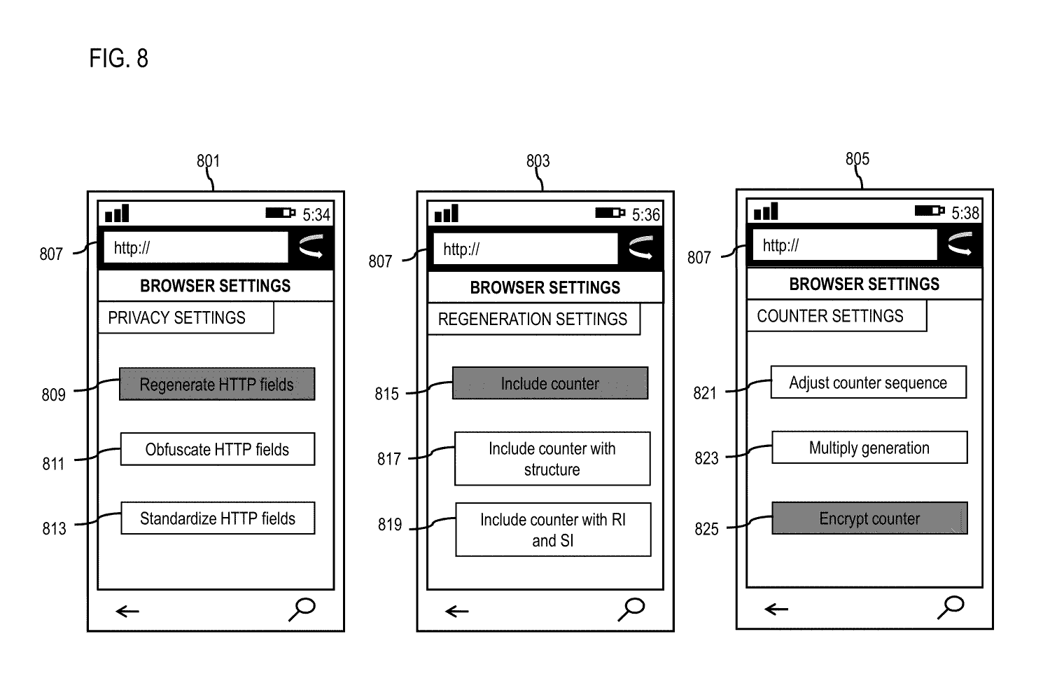

FIG. 8 are diagrams of user interfaces utilized in the processes of FIG. 3-5, according to various embodiments. As shown, the example user interfaces of FIG. 8 include one or more user interface elements and/or functionalities created and/or modified based, at least in part, on information, data, and/or signals resulting from the processes (e.g., processes 300, 400, 500, and 600) described with respect to FIGS. 3-5. More specifically, FIG. 8 illustrates three user interfaces (interfaces 801, 803, and 805) depicting one or more browser settings for the at least one web browser 807. In particular, the one or more browser settings relate to one or more privacy settings (e.g., interface 801), one or more regeneration settings (e.g., interface 803), and one or more counter settings (e.g., interface 805).

In one embodiment, as depicted in interface 801, the system 100 can cause, at least in part, one or more modifications of one or more of the respective one or more fields (e.g., Etags, User-Agent strings, etc.), the at least one web browser 807, or a combination thereof based, at least in part, on one or more amounts of information, one or more types of information, or a combination thereof associated with the identification. In particular, in this example use case, the interface 801 includes, at least in part, one or more buttons or interface elements for selecting one or more modifications of the one or more fields (e.g., buttons 809, 811, and 813). By way of example, a user can determine based on computational resources and time, for example, to regenerate the one or more fields (e.g., button 809), to obfuscate the one or more fields (e.g., button 811), or to standardize the one or more fields (e.g., button 813).

In this example use case, the user selected to regenerate the one or more fields as depicted by the “selected” button 809. As a result, the system 100 causes, at least in part, a presentation of one or more options for regenerating the one or more fields as depicted in interface 803. More specifically, in addition to regenerating the one or more fields, the system 100 can cause, at least in part, an association of a counter value with the one or more regenerated fields (e.g., button 815), with one or more CSRIs (e.g., button 817), or with all of the one or more fields within the structure as well as the structure itself (e.g., button 819).

In one embodiment, by selecting to associate a counter with the one or more regenerated fields as depicted by the “selected” button 815, the system 100 can then determine a counter value based, at least in part, one or more numerical values as depicted by button 821 (e.g., sequential and non-sequential values), one or more arguments as depicted by button 823 (e.g., a string such as “a”, “b”, “n”, etc.), or a combination thereof. In addition, the system 100 can also cause, at least in part, at least one encryption of the at least one counter value based, at least in part, on a key, an encryption function, or a combination thereof as depicted by the selected button 825. By way of example, the system 100 can extend the generation function with encryption or other facilities to hide the value of the counter (e.g., by encrypting with a public key that can only be decrypted by a suitable function and a private key found elsewhere).

The processes described herein for modifying unique identifiers and/or analyzing regenerated identifiers may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

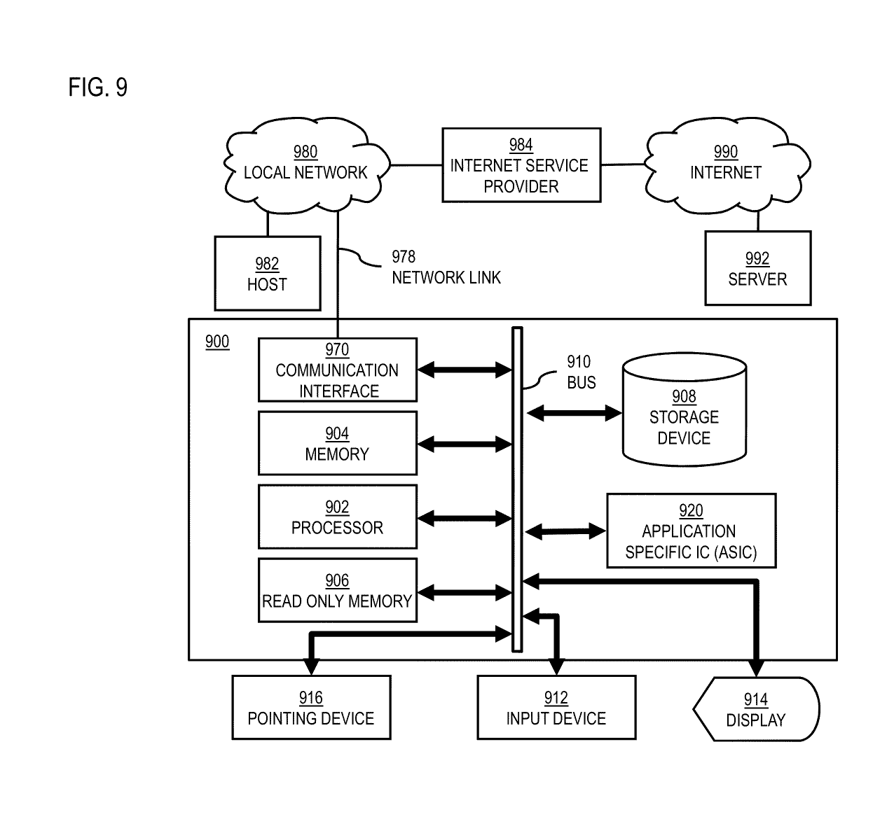

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to modify unique identifiers associated with a web browser and analyze regenerated identifiers as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of modifying unique identifiers and/or analyzing regenerated identifiers.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to modify unique identifiers associated with a web browser and analyze regenerated identifiers. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for modifying unique identifiers and/or analyzing regenerated identifiers. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for modifying unique identifiers and/or analyzing regenerated identifiers, is provided to the bus 910 for use by the processor from an external input device 912, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for modifying unique identifiers and/or analyzing regenerated identifiers to the UEs 101.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

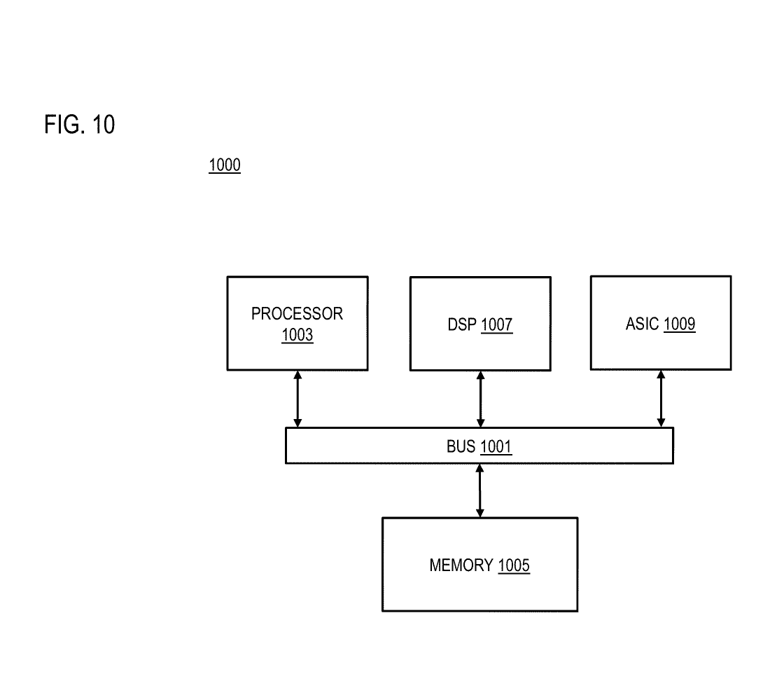

FIG. 10 illustrates a chip set or chip 1000 upon which an embodiment of the invention may be implemented. Chip set 1000 is programmed to modify unique identifiers associated with a web browser and analyze regenerated identifiers as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of modifying unique identifiers and/or analyzing regenerated identifiers.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to modify unique identifiers associated with a web browser and analyze regenerated identifiers. The memory 1005 also stores the data associated with or generated by the execution of the inventive steps.

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of modifying unique identifiers and/or analyzing regenerated identifiers. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of modifying unique identifiers and/or analyzing regenerated identifiers. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to modify unique identifiers associated with a web browser and analyze regenerated identifiers. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one determination of one or more fields associated with an identification of at least one web browser;
one or more modifications of respective ones of the one or more fields based, at least in part, on one or more amounts of information, one or more types of information, or a combination thereof associated with the identification; and
at least one transmission of data associated with the at least one web browser based, at least in part, on the one or more modified fields.

2. A method of claim 1, wherein the (1) data and/or (2) information and/or (3) at least one signal are further based, at least in part, on the following:
at least one determination of the respective one or more fields based, at least in part, on one or more requirements associated with the at least one transmission of data, at least one activation of a Do Not Track field, or a combination thereof; and
the one or more modifications based, at least in part, on the one or more requirements, the at least one activation, or a combination thereof.

3. A method of claim 2, wherein the (1) data and/or (2) information and/or (3) at least one signal are further based, at least in part, on the following:
at least one regeneration of the respective one or more fields based, at least in part, on one or more hashing parameters, one or more data encryption parameters, or a combination thereof,
wherein the one or more modifications include, at least in part, the one or more regenerated fields.

4. A method of claim 3, wherein the (1) data and/or (2) information and/or (3) at least one signal are further based, at least in part, on the following:
at least one concatenation of the respective one or more fields based, at least in part, on at least one data structure,
wherein the one or more modifications, the at least one regeneration, or a combination thereof is based, at least in part, on the at least one concatenated fields.

5. A method of claim 3, wherein the (1) data and/or (2) information and/or (3) at least one signal are further based, at least in part, on the following:
at least one determination of a counter value based, at least in part, on one or more numerical values, one or more arguments, or a combination thereof; and
an association of the counter value with the one or more regenerated fields, the one or more concatenated fields, or a combination thereof.

6. A method of claim 5, wherein the (1) data and/or (2) information and/or (3) at least one signal are further based, at least in part, on the following:
at least one encryption of the at least one counter value based, at least in part, on a key, an encryption function, or a combination thereof.

7. A method of claim 2, wherein the (1) data and/or (2) information and/or (3) at least one signal are further based, at least in part, on the following:
at least one obfuscation of the respective one or more fields,
wherein the one or more modifications are based, at least in part, on the obfuscation.

8. A method of claim 2, wherein the (1) data and/or (2) information and/or (3) at least one signal are further based, at least in part, on the following:
at least one determination of at least one standard for the at least one transmission of data; and
at least one standardization of the respective one or more fields based, at least in part, on the at least one standard,
wherein the one or more modifications are based, at least in part, on the standardization.

9. A method of claim 2, wherein the (1) data and/or (2) information and/or (3) at least one signal are further based, at least in part, on the following:
at least one removal of the non-respective one or more fields based, at least in part, on the one or more requirements associated with the at least one transmission of data.

10. A method of claim 1, wherein the one or more fields include, at least in part, one or more Hypertext Transfer Protocol headers associated with the at least one transmission of data, the at least one web browser, or a combination thereof.

11. An apparatus comprising:
at least one processor; and
at least one memory including computer program code for one or more programs,
the at least one memory and the computer program code configured to, with the at least one processor, cause the apparatus to perform at least the following:
determine one or more fields associated with an identification of at least one web browser;
cause, at least in part, one or more modifications of respective ones of the one or more fields based, at least in part, on one or more amounts of information, one or more types of information, or a combination thereof associated with the identification; and
cause, at least in part, at least one transmission of data associated with the at least one web browser based, at least in part, on the one or more modified fields.

12. An apparatus of claim 11, wherein the apparatus is further caused to:
determine the respective one or more fields based, at least in part, on one or more requirements associated with the at least one transmission of data, at least one activation of a Do Not Track field, or a combination thereof; and
cause, at least in part, the one or more modifications based, at least in part, on the one or more requirements, the at least one activation, or a combination thereof.

13. An apparatus of claim 12, wherein the apparatus is further caused to:
cause, at least in part, at least one regeneration of the respective one or more fields based, at least in part, on one or more hashing parameters, one or more data encryption parameters, or a combination thereof,
wherein the one or more modifications include, at least in part, the one or more regenerated fields.

14. An apparatus of claim 13, wherein the apparatus is further caused to:
cause, at least in part, at least one concatenation of the respective one or more fields based, at least in part, on at least one data structure,
wherein the one or more modifications, the at least one regeneration, or a combination thereof is based, at least in part, on the at least one concatenated fields.

15. An apparatus of claim 13, wherein the apparatus is further caused to:
determine a counter value based, at least in part, on one or more numerical values, one or more arguments, or a combination thereof; and
cause, at least in part, an association of the counter value with the one or more regenerated fields, the one or more concatenated fields, or a combination thereof.

16. An apparatus of claim 15, wherein the apparatus is further caused to:
cause, at least in part, at least one encryption of the at least one counter value based, at least in part, on a key, an encryption function, or a combination thereof.

17. An apparatus of claim 12, wherein the apparatus is further caused to:
cause, at least in part, at least one obfuscation of the respective one or more fields,
wherein the one or more modifications are based, at least in part, on the obfuscation.

18. An apparatus of claim 12, wherein the apparatus is further caused to:
determine at least one standard for the at least one transmission of data; and
cause, at least in part, at least one standardization of the respective one or more fields based, at least in part, on the at least one standard,
wherein the one or more modifications are based, at least in part, on the standardization.

19. An apparatus of claim 12, wherein the apparatus is further caused to:
cause, at least in part, at least one removal of the non-respective one or more fields based, at least in part, on the one or more requirements associated with the at least one transmission of data.

20. An apparatus of claim 11, wherein the one or more fields include, at least in part, one or more Hypertext Transfer Protocol headers associated with the at least one transmission of data, the at least one web browser, or a combination thereof.

21.-48. (canceled)
